(19) United States
(12) Patent Application Publication
(10) Pub. No.: US 2007/0005187 A1
(43) Pub. Date: Jan. 4, 2007

(54) Interactive method and device for providing assistance with manual movements during material processing

(76) Inventor: Philippe Bellanger, Izeron (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/553,468

(22) PCT Filed: Apr. 13, 2004
(86) PCT No.: PCT/FR04/00903

§ 371 Date: Nov. 3, 2005

(30) Foreign Application Priority Data
Apr. 17, 2003 (FR) 03/04804

(51) Int. Cl. G06F 19/00

(52) U.S. Cl. 700/245

(57) ABSTRACT

A method for providing assistance and computer-aided learning with regard to manual movements of an operator during processing of a material, for example in the fields of plastic arts, design, industrial machining, paramedical professions, and surgery. The method is based on a device that includes one or more metrologic systems used for continuously measuring a position of a tool and the material. A computer acquires data issued by the metrologic system and propagates the effect of displacements of the tool relative to the material that is to be machined to one or more digital models, and an interface generates acoustic and/or optical and/or haptic stimuli that supply information to the operator by increasing the reality of the actions/reactions which his/her job involves.

### TECHNICAL FIELD

The invention relates to a method and device for providing assistance and computer-aided learning with regard to the manual movements of an operator, for the purpose of either reproducing an existing shape or creating a new shape.

The invention is capable of being integrated into or arranged in a material design or processing line, especially, but not exclusively, in the fields of plastic arts, design, industrial machining, paramedical professions and surgery.

The invention relates more particularly to a method that is based on a device which, in order to provide assistance and aid in learning with regard to movements, uses a digital representation of the shape being reproduced and the material being processed.

The problem of reproducing shapes from a digital model can be partially resolved by the use of robotic solutions. However, this technique reaches its limits when the complexity of the shapes being reproduced necessitates specific movements but also when the number of objects being reproduced is small compared with the investment required to program the paths or trajectories.

Another approach consists in keeping those skilled in the art at the center of the reproduction process loop, while continuously furnishing them with all of the data necessary and sufficient to enable them to work on the material safely.

For this approach, a certain number of documents describe devices that integrate, on one hand, metrologic means and, on the other hand, a system of three-dimensional representations of a digital object. Thus, French Patent FR 2 808 366 (AZERAD J.; BLANCHARD J.; MAURIN Y.) describes a method for virtual reality training consisting of various elements: sensing data concerning the spatial position of a real hand-held unit, a three-dimensional representation of a digital object, supplying a digital tool capable of operating on the digital object. At no time does the method allow for the machining of a real material, and even less so a possible resumption of the machining of the real material in a digital model, thereby enabling a conceptual intervention in both worlds. For this reason, it is impossible to provide data for complete training by means of manual movements during processing of a material. Consequently, this method does not meet the needs expressed by the professions that process the material.

### SUMMARY OF THE INVENTION

A purpose of this invention is to propose an iterative action/information method based on a device enabling assistance with manual movements so as to confer a shape on a material that approximates a digital model. A device such as this makes it possible to optimize the nature and amount of data required for spatially controlling the treatment of the material.

Another purpose of the invention is to propose a device to provide assistance and learning with regard to manual movements during processing of the material that, on the one hand, enables analysis of the methodology of the movements and, on the other hand, reading of the result in the form of a digital model of the machined material.

To this end, the invention relates to a device that implements one or more digital models, among which the following are identified:
the model to be attained, referred to as the “mother model”, built from a source model (digitization data, CAD model) enhanced with profession-related data and/or transformed (scaling, simplification, etc.)
the model of the material to work or process, referred to as the “material to process model” built from data derived from a physical volume or from digital data specifying the dimensions of the material to process.
the “tool model” specifying the physical and geometric parameters of the work tool (reaction reserve, diameter of the tool, eccentricity, etc.). This model is used to calculate the effect of the tool on the material, and the result of this calculation serves to continuously update the “machined material model”.
the “movements model” contains the description of the tool's configurations during processing of the material.
the “machined material model” is the result of the actions of the tool on the material being machined.

These models enable those skilled in the art to express their needs and to explore the possible alternatives within the space being machined. They may be the basis of an identical reproduction or a partial or global homothety, or a transformation by addition or subtraction in the virtual as well as in the real world. Another possibility offered by this system is to be able to take into account the displacements of the material by continuously measuring them, making it possible to maintain the action of the tool on the material, thanks to a continuous balancing of the various models.

### BRIEF DESCRIPTION OF THE DRAWINGS

The invention will be well understood upon reading the following description, with reference to the appended drawings which, by way of a non-limiting example, represent an assistance and learning device for providing assistance with manual movements within a space, wherein:

FIG. 1 represents an overall schematic view of the assistance and learning device for providing assistance with manual movements within a space, according to the invention.

FIGS. 2 and 3 represent possible visual data and display examples (video projection and monitor screen) according to the invention;

According to the invention, the assistance and learning device for manual movements within a space is designed to be used in several ways, depending on the field of application.

A first way consists in processing a material 19 without relying on a “mother model” M1; in this case the manual movements free of any constraints enable direct creation processing, and the result derived therefrom is stored in a “machined material model” M4. The iterative process belonging to this invention makes it possible to reuse this result for a reproduction, after it has been adapted as a “mother model” M1.

A second way consists in continuously representing the action of a tool 3 on the material 19 by a transformation of the state of the “machined material model” M4. In this case, for the purposes of dimensional inspection, it is possible to compare the “machined material model” M4 and the “mother model” M1, so as to produce a three-dimensional map of the errors. Another use of this result is to track the evolution of the processing over time.

A third but non-exclusive way consists in using the position measurements of the tool 3 supplied by a metrologic system 4 to specify the elements for generating a reference movement, with a view to re-executing it by means of an automated system such as a robot.

In reality, this device may be introduced as a design tool and/or a pedagogical and play tool. Therefore, it is a question of the needs anticipated by the professions, especially, but not exclusively, in the fields of plastic arts, design, industrial machining, paramedical professions and surgery.

Thus, the example cited in the appended diagrams shows the use of the device in the field of plastic arts (reproduction of a digitized sculpture). It may be assumed that the invention is not limited to this embodiment but, on the contrary, the invention may include other alternatives associated with the various fields.

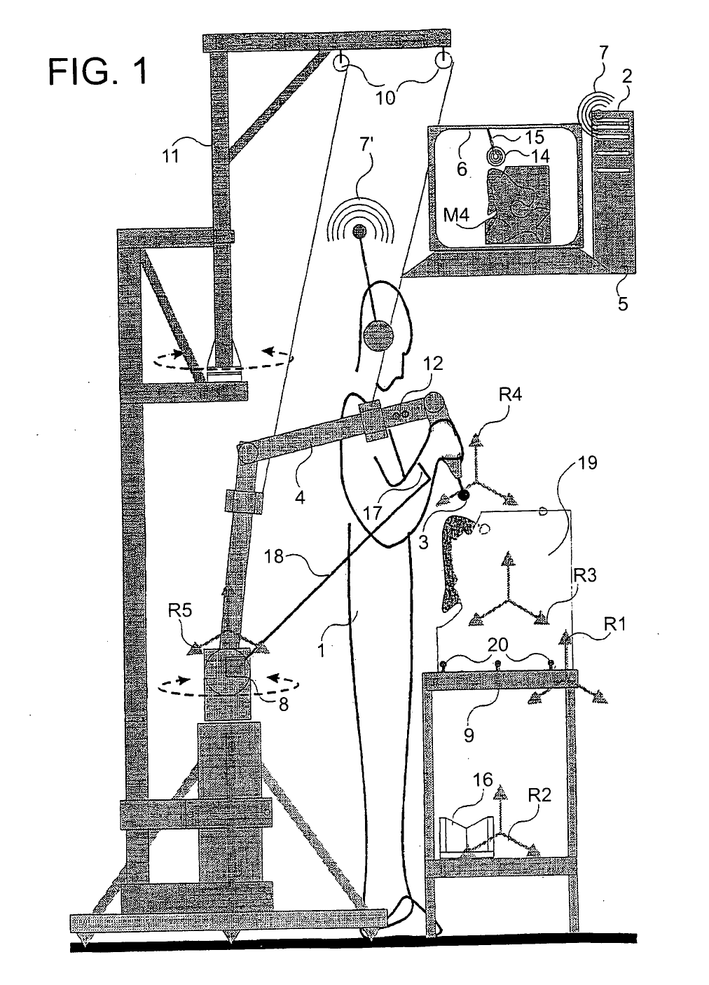

As illustrated in FIG. 1, the device consists primarily of the following elements
an operator 1.
a work station 9, associated with an absolute reference system R1 consisting of a material support modeled by a three-dimensional reference system R3, an tool calibration system 16 modeled by a three-dimensional reference system R2, and a set of target objects 20 used for resetting, and defined, respectively, in relation to the absolute three-dimensional reference system R1.
a calculator or computer (of the microcomputer type) 2 integrating the data from the models and their effects.

a tool 3 modeled by a three-dimensional reference system R4 arranged on a metrologic system 4 (an articulated arm swivel arm or follower) associated with a three-dimensional reference system R5 defined in relation to the absolute three-dimensional reference system R1, continuously delivering to the computer 2 the data relating to the position and orientation of the tool 3.

a stimuli generator 5 consisting of optical 6, acoustic 7 and/or haptic 8 channels informing the operator 1 of the effect of his/her movements on the material 19.

According to FIG. 1, the microcomputer-type computer 2, which integrates the data from the digital models and their effects, comprises a hardware portion consisting of highly-integrated electronic circuits and software programs. The function of a computer is limited to sequencing, classifying, calculating, sorting, searching, editing and representing data that have been pre-encoded according to a binary representation.

As can be seen in FIG. 1, the device, as concerns its metrologic system 4, consists of a measuring arm having several degrees of freedom, which continuously informs the computer 2 of all of the displacements of the free end induced by manual movements. Based on this data, the computer 2 updates all of the models.

The first function of the metrologic system 4 is to serve in measuring the reference systems such as the material reference system R3, and the reference system R2 of the tool calibration system 16, so as to calibrate the work station 9. Owing to the entire set of target objects 20, the position of the metrologic system 4 can be modulated, thereby enabling the intervention space to be increased beyond its own work volume.

The second function of the metrologic system 4 is to serve in continuously measuring the position and orientation of a tool 3 in relation to the machined material 19.

The tool 3 designed to machine the material 19 is rigidly connected to the metrologic system 4. It may consist of a milling cutter, disk, spherical spatula or any other work tool, depending on the applications and materials selected. As a result of the measurement, the effect of the tool 3 is translated into the “machined material model” M4 by way of the “tool model” M3, while being based on the “mother model” M1 placed inside the “material to process model” M2.

The metrologic system 4 might be a localization system of the optical or magnetic “follower” type, preferable for certain applications or for certain work phases.

The metrologic system 4 must be manually and freely manipulatable.

In the case where a measuring arm is used and for easier handling, the metrologic system 4 is balanced by an adjustable pull-back system, such as an equalizer or lifting device 10, conferring an increased degree of fluidity upon the movements of the operator. This lifting unit 10 is installed above the arm by means of a rotating jib 11 whose axis of rotation is aligned with the base axis of the measuring arm.

In the examples shown in FIG. 1, the device consists of a work station 9, which is a rigid system enabling the operator to adjust the height of the material support. The tool calibration system consists of a trihedral object 16 serving as a reference in calibrating the tools 3 installed at the end of the arm.

The stimuli generator 5, remotely controlled by the operator 1 by means of a device 12 mounted on the metrologic system 4, makes available to the latter optical 6, acoustic 7 or haptic 8 stimuli used separately or in combination.

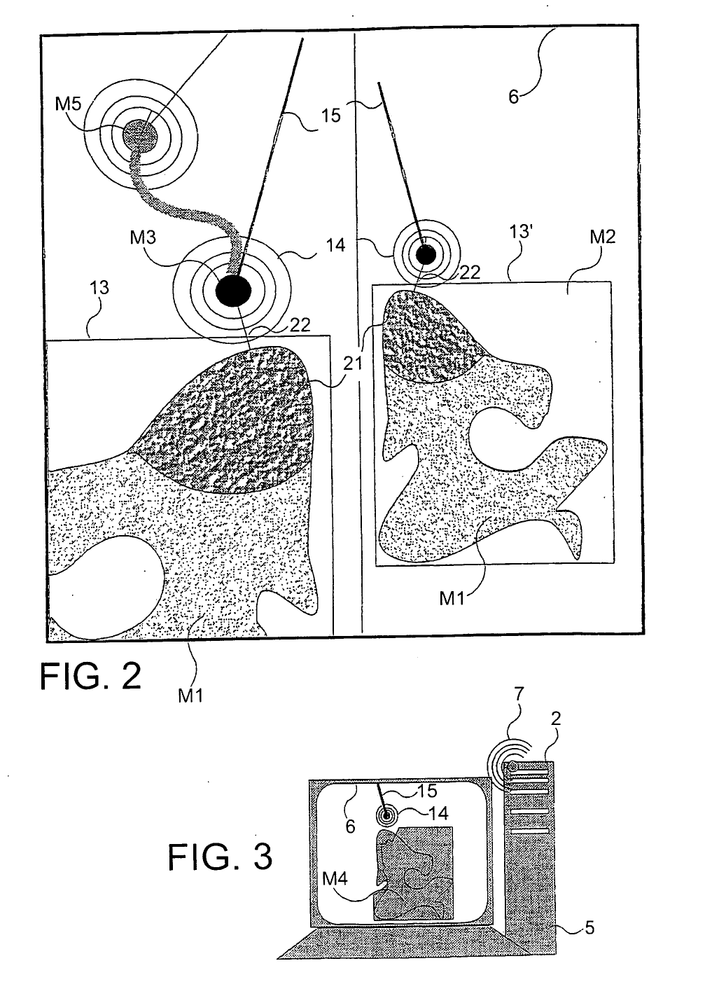

According to one possibility and as in FIG. 2, an optical stimulus may be a video projection 6 of the digital models as seen in one or more views 13 and 13′ characterized, among other things, by a viewpoint and a scaling factor that can be programmed by the operator 1, in which the tool 3 is represented continuously and throughout all of its movements, displayed as a reaction sphere 14 that can be programmed in relation to the density/scale factor of the material being machined, the representation of the latter being enhanced by the physical representation of the axis of support 15 of the tool and of the shortest path 22 separating the tool from the closest possible punctual contact in the “mother model” M1. One-important feature of the display is that of having a locally improved resolution 21, by adjusting certain characteristics, such as the surface menu or the light, to the exact sequence of the movements of the tool in space, enabling the operator 1 to continuously interpret the locations of the tool M3 in relation to the “mother model” M1 and to the shape machined from the material 19.

According to another possibility, an acoustic stimulus is transmitted by modulatable sounds 7 (FIG. 3) and received in a headset 7′ (FIG. 1); these sounds can be adjusted in frequency and amplitude. The frequency is determined continuously during processing of the material, on the basis of the distance of the tool and its back-up M3 to the closest possible punctual contact calculated in the “mother model” M1. The frequency and distance scales can be programmed by the operator. The amplitude can be manually adjusted in relation to the sound level in the workstation environment.

According to another possibility, a haptic stimulus 8 can be generated by a pull-back in force in relation to the distance of the tool and its back-up M3 from the closest possible punctual contact calculated in the “mother model” M1. The pull-back in force might be ensured by a system consisting of a bracelet 17, positioned on the operator's 1 wrist or on the metrologic system 4, and joined by a flexible connection 18 to a motorized mechanism which gradually exerts a pull-back force until the end of the tool M3 reaches a point on the envelope of the “mother model” M1.

Based on this, the invention relates to a method for providing assistance and learning with regard to the manual movements of an operator for the purpose of processing a material, on the one hand, it includes the following elements:
a digital representation of the shape to be attained (designated as “mother model” M1),
a digital representation of the material to work or process set in relation to an absolute three-dimensional reference system R1 (designated as “material to process or to work model” M2),
a digital representation of the tool resulting from a scaling step (designated as “tool model” M3),
a material to be transformed 19, set in relation to an absolute three-dimensional reference system R1,
data and action means in the device as described,

and, on the other hand, in that it includes the following steps:

Step 1: the purpose in creating the “mother model” M1 is to convert the geometric envelope of the volume being reproduced into three-dimensional coordinates capable of being manipulated by a computer. A created digital model can be enhanced, simplified or sectored according to the needs specific to each profession. This step can be carried out independently of the other steps.

Step 2: by means of measurements taken in the absolute three-dimensional reference system R1, the scaling of the work station 9 makes it possible to specify, on one hand, the three-dimensional reference system R3 of the material support and the three-dimensional reference system R2 of the tool scaling system and, on the other hand, the three-dimensional reference system R5 of the metrologic system.

Step 3: the creation of the “material to process model” M2 is achieved either by acquiring the digital data of a pre-existing external volume, or by determining the volume to be machined that corresponds to the external envelope of the volume being reproduced.

Step 3: the scaling of the tool 3 consists in relying on a preset reference surface 16 of the scaling system in the absolute three-dimensional reference system R1 in order to determine certain parameters of the “tool model” M3, such as length and eccentricity, and to specify the other parameters such as the reaction sphere. This makes it necessary that the work station 9 be scaled.

Step 4: the placement of the “mother model” M1 in relation to the “material to process model” M2 enables a computer-aided positioning of the digital representation of the shape to be attained inside of the digital representation of the block of material to process. The parameterization of the position, orientation and scale of the shape to be attained in relation to the block of material enables a rapid placement in order to produce reproductions that are identical (scale 1/1) or enlarged (scale>1) or reduced (scale<1). Using this approach, the “mother model” M1 is plotted in the “material to process model” M2, for the duration of the job, either by being obligated to respect the dimensions of the volume being reproduced (identical, larger, smaller) or by respecting the volume of the material in order to best plot therein the volume being reproduced.

Step 5: the processing of the material can be carried out according to two possible approaches: the creation of a shape by direct carving, which requires that the three steps 2, 3 and 4 be accomplished, or a reproduction, which requires the four steps 1, 2, 3 and 4. With the operator 1 having pre-selected and adjusted the stimuli 5 (6, 7 and 8) that he/she wishes to have in return, the position and orientation of the tool 3 in space are processed constantly by the computer 2 which, based on knowledge of the various models M1, M2, M3 and M4, calculates the characteristic quantities (collisions, minimal distance, scanned volume) of the effect of the tool 3 on the material 19. This effect is then translated into the form of stimuli 5 sent to the operator. Owing to the multi-view display 6, among other things, the operator is able to know at any moment, on the one hand, the position of the tool 3 in relation to the shape to be attained M1 and, on the other hand, the effect of the tool on the material by way of the evolution of the “machined material model” M4.

It is possible for the operator to suspend processing of the material at any moment to analyze the results furnished by the digital models of the machined material M4 and of the movements M5 and/or to change tools 3 based on the evolution of the processing carried out and/or to save onto the computer 2 all of the data translating the status of his/her job.

Changing the tool 3 involves carrying out a scaling of the tool (cf. Step 3) for the purpose of determining the parameters of the new tool 3. Once this step has been carried out, the identified changes are propagated automatically and it becomes possible to resume processing of the material 19.

The operator 1 must perform the same operations on the material 19 as those routinely practiced by his/her profession. One of the primary difficulties that must be dealt with in order to obtain high-quality processing of the material is the mental transcription of the shape to be attained from the material, which must be performed continuously by the operator. Thanks to the adaptation of the various stimuli sent to the operator with respect to the position of the tool in relation to the material, the operator receives on-going assistance with his/her movements, the quality of which is irrespective of the ambient conditions of the work environment. This relieves the operator of the mental transcription work and enables him/her to concentrate on processing the material that has been made transparent. The device possesses measuring means that make it possible to learn movements for training purposes, for pedagogical purposes, for analysis of movements or for programming robot systems, among others.

1-9. (canceled)

10. A device for providing computer-aided assistance with movements continuously during processing of a material, comprising:
a referent of the material to process defined according to an absolute reference system;
a work station equipped with target objects having a function of resetting a metrologic system after it has been displaced;
a tool scaling system;
at least one tool for machining the material;
an absolute reference system serving as a referent for a computer carrying out acquisition, storage, and processing of data issued by the metrologic system and continuously propagating an effect of displacements of the at least one tool, relative to the material to be machined and that is being processed, to one or more digital models, wherein the metrologic system has a function of continuously measuring a position of the at least one tool and of the material to be machined and that is being processed; and
a stimuli generator continuously informing an operator of the position of the at least one tool relative to the material to be machined and that is being processed, by increasing reality of actions/reactions that the operator's job involves, by a choice of multiple and simultaneous sensory returns.

11. A device according to claim 10, wherein the metrologic system comprises an articulated arm for measuring or a localization system holding the at least one tool, and is balanced by an adjustable lifting system.

12. A device according to claim 10, wherein the position of the metrologic system is modulated and identified with aid of an entire set of target objects placed on the work station.

13. A device according to claim 10, wherein, at any instant, measurable displacements of the material are taken into account to enable action of the at least one tool on the material, based on continuous balancing of the one or more digital models with the absolute reference system.

14. A device according to claim 10, wherein the stimuli generator supplies sensory returns of multiple view type, at variable scales, of the one or more digital models in which the at least one tool is represented throughout all its displacements, displayed as a reaction reserve that can be programmed in relation to density/scale factor of the material being machined.

15. A device according to claim 10, wherein the stimuli generator supplies sensory returns of sound type and/or a pull-back in force that have variable and increasing intensity in relation to a gradual approach of the at least one tool and its reserve in the one or more digital models with respect to a closest possible punctual contact.

16. A device according to claim 10, wherein representation of the at least one tool in views is enhanced by a physical representation of an axis of support of the at least one tool and of a shortest path separating a tool model from a closest possible punctual contact in the one or more digital models.

17. A device according to claim 10, wherein display of the one or more digital models of a shape to be attained has a locally improved resolution, and is preset by characteristics to an exact sequence of movements of the at least one tool in space.

18. A device for providing computer-aided assistance with movements continuously during processing of a material, comprising:
a referent of the material to process defined according to an absolute reference system;
a work station equipped with target objects having a function of resetting a metrologic system that can be modulated and identified with aid of an entire set of target objects placed on the work station after it has been displaced;
a tool scaling system;
at least one tool for machining the material;
an absolute reference system serving as a referent for a computer carrying out acquisition, storage, and processing of data issued by the metrologic system and continuously propagating an effect of displacements of the at least one tool relative to the material to be machined and that is being processed, to one or more digital models, wherein the metrologic system has a function of continuously measuring a position of the at least one tool and of the material to be machined and that is being processed;
a stimuli generator continuously informing an operator of the position of the at least one tool relative to the material to be machined and that is being processed, by increasing reality of actions/reactions that the operator's job involves, by a choice of multiple and simultaneous sensory returns, the stimuli generator supplying sensory returns of multiple view type, at variable scales, of the one or more digital models in which the at least one tool is represented throughout all its displacements, displayed as a reaction reserve that can be programmed in relation to density/scale factor of the material being machined, or the stimuli generator supplying sensory returns of sound type and/or a pull-back in force that have variable and increasing intensity in relation to a gradual approach of the at least one tool and its reserve in the one or more digital models with respect to a closest possible punctual contact.

19. A device according to claim 18, wherein the metrologic system comprises an articulated arm for measuring or a localization system holding the at least one tool, and is balanced by an adjustable lifting system.

20. A device according to claim 18, wherein, at any instant, measurable displacements of the material are taken into account to enable action of the at least one tool on the material, based on continuous balancing of the one or more digital models with the absolute reference system.

21. A device according to claim 18, wherein representation of the at least one tool in views is enhanced by a physical representation of an axis of support of the at least one tool and of a shortest path separating a tool model from a closest possible punctual contact in the one or more digital models.

22. An iterative action/information method for providing continuous computer-aided assistance and learning with regard to manual movements during processing of a material, comprising:
defining at least one reference system with a view to scaling a work station;
defining at least one digital model of a shape to be attained of a material to process, in relation to a referent known at any instant in relation to an absolute reference system;
establishing a placement of the at least one digital model of a shape to be attained in the at least one digital model of the material to process;
defining a digital model of the tool specified by the physical and geometric parameters designed to machine the material by scaling it according to a reference system known at any instant in relation to the absolute reference system;
obtaining necessary data for knowing a position of the at least one tool in relation to the at least one digital model of the shape to be attained;
obtaining a quasi-simultaneous updating of the at least one digital model of a machined material with respect to effect of the at least one tool on the material, which is induced by manual movements of an operator; and
obtaining a quasi-simultaneous analysis of the work results furnished by the at least one digital model of the machined material and of the movements.
